(19) United States
(12) Patent Application Publication
(10) Pub. No.: US 2006/0087852 A1
(43) Pub. Date: Apr. 27, 2006

(54) Light device

(75) Inventors: Simon Nicholas Richmond, Coogee (AU); Liu Zihui, Guangzhou (CN)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Simon Nicholas Richmond, Coogee (AU)

(21) Appl. No.: 11/057,077

(22) Filed: Feb. 11, 2005

(30) Foreign Application Priority Data
Feb. 13, 2004 (AU) 2004900700

(51) Int. Cl. F21V 21/00

(52) U.S. Cl. 362/374; 362/375; 362/392

(57) ABSTRACT

A light device (10, 30) is described which comprises a first portion (12) configured so as to partially define a housing, the first portion (12) being arranged so as to at least partially pass light therethrough and the first portion (12) including first electrical contacts (46, 48) and a first locking device (50), a light emitting element (15) disposed in the first portion (12) and being electrically connected to the first electrical contacts (46, 48) and a second portion including a battery compartment (56), second electrical contacts (52, 54) arranged so as to be in electrical connection with batteries disposed in the battery compartment during use, and a second locking device (62, 64) engageable with the first locking device (50) so as to releasibly fix the second portion (13) to the first portion (12) during use and thereby close the housing. The arrangement is such that, during use, when the first and second locking devices (50, 62, 64) are engaged with each other, the first electrical contacts (50) electrically connect with the second electrical contacts (62, 64) so as to thereby electrically connect batteries disposed in the battery compartment (56) during use to the at least one light emitting element (15).

### FIELD OF THE INVENTION

The present invention relates to a light device.

### BACKGROUND OF THE INVENTION

It is known to provide a light device which includes a light source in the form of one or more LEDs, batteries arranged to supply power to the LEDs, and a control unit arranged to cause the LEDs to emit light which flickers. In one such prior art light device, the LEDs are disposed inside a lantern-type housing.

However, with this arrangement, the batteries are often disposed in a lid portion of the housing and electrically connected to the LEDs in the housing. As a consequence, the task of replacing the batteries is relatively cumbersome.

### SUMMARY OF THE INVENTION

In accordance with an aspect of the present invention, there is provided a light device comprising:

a first portion configured so as to partially define a housing, the first portion being arranged so as to at least partially pass light therethrough and the first portion including first electrical contacts and a first locking device;

a light emitting element disposed in the first portion and being electrically connected to the first electrical contacts; and

a second portion including a battery compartment, second electrical contacts arranged so as to be in electrical connection with batteries disposed in the battery compartment during use, and a second locking device engageable with the first locking device so as to releasibly fix the second portion to the first portion during use and thereby close the housing;

the arrangement being such that, during use, when the first and second locking devices are engaged with each other, the first electrical contacts electrically connect with the second electrical contacts so as to thereby electrically connect batteries disposed in the battery compartment during use to the at least one light emitting element.

One of the first and second locking devices may include at least one generally L-shaped member provided with an outwardly extending locking member, and the other of the first and second locking devices may include at least one cavity portion and at least one associated projection, each projection locating under a locking member when the first and second locking devices are engaged with each other.

Preferably, four L-shaped members are provided and four corresponding cavity portions and projections.

Preferably, the first locking device includes the at least one generally L-shaped member and the second locking device includes the at least one cavity portion and at least one associated projection.

In one arrangement, each first electrical contact includes a raised portion arranged so as to encourage good electrical contact with a second electrical contact during use.

In one arrangement, each second electrical contact is formed of resilient material so as to encourage good electrical contact with a first electrical contact during use.

In one arrangement, the first portion is a base portion of the light device, and the second portion is a lid portion of the light device.

In one arrangement, the base portion includes at least one transparent panel and a simulated candle having at least one light emitting element disposed in the simulated candle, the simulated candle being arranged so as to diffuse light passing therethrough from the at least one light emitting element.

In an alternative arrangement, the base portion includes at least one translucent panel and the at least one light emitting element is disposed in the base portion such that light from the at least one light emitting element is diffused by the at least one translucent panel. The or each translucent panel may be formed of frosted glass.

In one embodiment, the light device further comprises a control unit for causing the at least one light emitting element to emit flickering light. The light device may further be arranged such that the control unit is activatable and deactivatable under control of a user so as to activate or deactivate flickering of the at least one light emitting element.

The or each light emitting element may be an LED. Each LED may be arranged so as to emit yellow or amber coloured light.

In one arrangement, the light device includes a solar power converting device arranged to convert solar power to electrical power, and an electrical power storage device arranged to store electrical power provided by the solar power converting device.

The light device may be of lantern-type appearance.

### BRIEF DESCRIPTION OF THE DRAWINGS

The present invention will now be described, by way of example only, with reference to the accompanying drawings, in which:

FIG. 1 is a diagrammatic perspective view of a light device in accordance with an embodiment of the present invention;

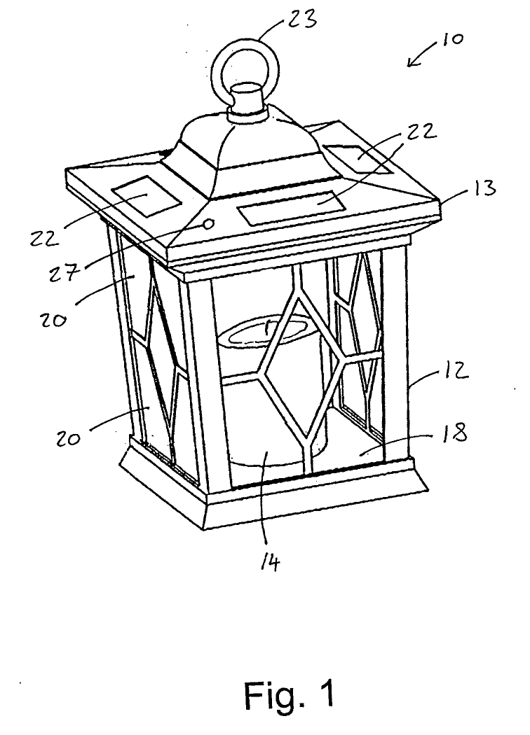

FIG. 2 is a block diagram showing components of the light device shown in FIG. 1;

FIG. 3 is a diagrammatic perspective view of the light device shown in FIG. 4 with a lid portion of the light device shown rotated relative to a base portion of the light device;

FIG. 4 is a diagrammatic perspective view of an upper portion of the base portion the light device shown in FIG. 1;

FIG. 5 is a further diagrammatic perspective view of the upper portion of the base portion shown in FIG. 4; and

FIG. 6 is a diagrammatic perspective view of a lower portion of the lid portion of the light device shown in FIG. 1.

### DETAILED DESCRIPTION OF AN EMBODIMENT OF THE INVENTION

Referring to the drawings, there is shown a light device 10 which includes a base portion 12 and a lid portion 13. The light device 10 is of lantern-type appearance.

Mounted on the lid portion and disposed inside the base portion 12 during use is a light source. In this example, the light source is in the form of a simulated candle 14 having one or more light emitting elements such as LEDs 15 disposed inside the simulated candle 14. The simulated candle 14 is arranged so that light passing through the simulated candle 14 from the light emitting elements is diffused.

The or each LED 15 may be of a type which emits yellow or amber light.

The base portion 12 includes transparent panels 20, although it will be understood that as an alternative to providing a simulated candle which diffuses light from the LEDs 15, a plurality of translucent panels may be provided to diffuse light passing through the panels during use. In this example, the translucent panels may be frosted glass, although it will be understood that other translucent panels may be used.

The light device 10 also includes a solar power converting device, in this example in the form of solar panels 22, which serves to convert solar power to electrical power. The solar panels 22 may be in the form of encapsulated polycrystalline PV solar panels or any other suitable solar power converting device.

The light device 10 also includes means, in this example a ring member 23, for facilitating hanging of the light device 10 from a structure. However, it will be understood that any suitable hanging means may be provided.

In an alternative embodiment or additionally, the light device 10 may include a spike extending downwardly from a lower wall portion 18 of the light device 10, the spike for example facilitating mounting of the light device 10 to a ground portion of a garden.

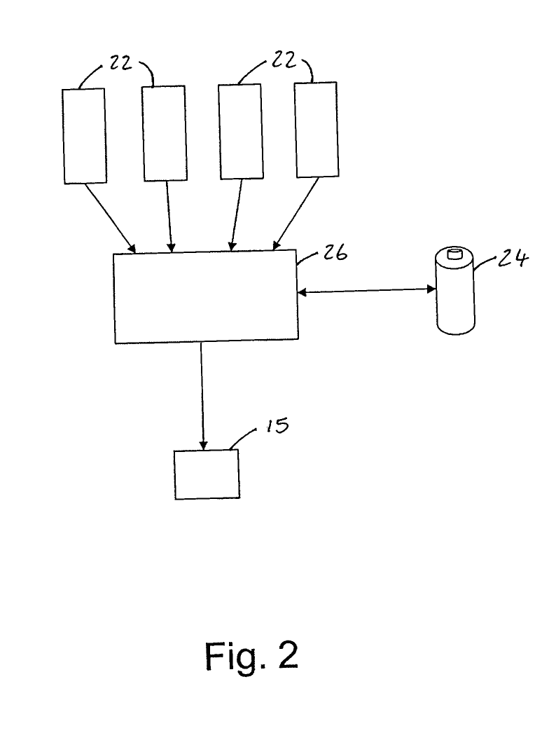

As shown in FIG. 2, electrical power supplied by the solar panels 22 serves to recharge a rechargeable power source, in this example rechargeable batteries 24 which may be NiCd batteries.

In order to coordinate supply of electrical power from the solar panels 22 to the rechargeable batteries 24 and from the rechargeable batteries 24 to the light source 14, a control unit 26 is provided.

The control unit 26 may also be arranged to sense the ambient light level, for example using a light dependent resistor 27 and, if a determination is made that sufficient ambient light is available for recharging the batteries using the solar panels, a connection is made between the solar panels 22 and the batteries 24 and a recharge current flows from the solar panels 22 to the batteries 24. If a determination is made that insufficient ambient light is available, a connection is not made between the solar panels 22 and the batteries 24 and a current does not flow to the batteries 24.

The light device 10 may also be arranged to receive power directly from an external power supply, for example by providing the light device 10 with an appropriate step-down transformer (not shown) connectable to mains AC electrical power and appropriate AC to DC conversion circuitry.

In order to cause the or each LED 15 in the light source to flicker, the control unit 26 may be provided with an inverter (not shown) and the inverter controlled so as to generate an alternating current arranged so as to cause the LED(s) 15 to mimic the characteristic flicker of a flame. Alternatively, an irregular oscillating input may be applied to a switching transistor so as to cause irregular switching of current through the LED(s) 15. Appropriate biasing signals for the switching transistor may be generated using multiple oscillators, each of which is arranged to oscillate at a different frequency. For example, a base of the switching transistor may be connected to outputs of multiple Schmitt trigger oscillators arranged to oscillate at different frequencies, the Schmitt trigger oscillators for example being constructed using a CMOS 40106 hex inverting Schmitt trigger integrated circuit.

The control unit 26 may be controllable so that the light source may be caused to flicker or to not flicker, for example in response to input from a manually operable switch.

It will be understood that the simulated candle 14 causes the flickering light to diffuse and thereby provide an effect which more closely resembles the effect produced by a flickering candle than light devices known hitherto.

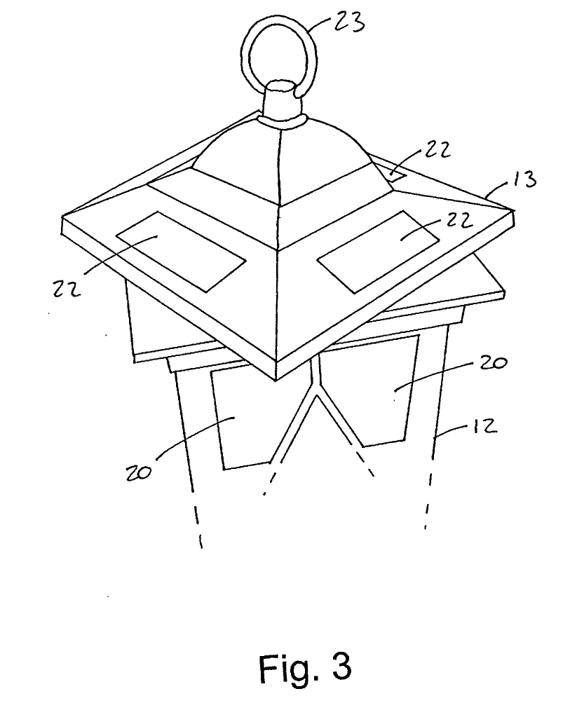

The lid portion 13 is removably attachable to the base portion 12 by rotating the lid portion 13 relative to the base portion 12, as shown in FIG. 3.

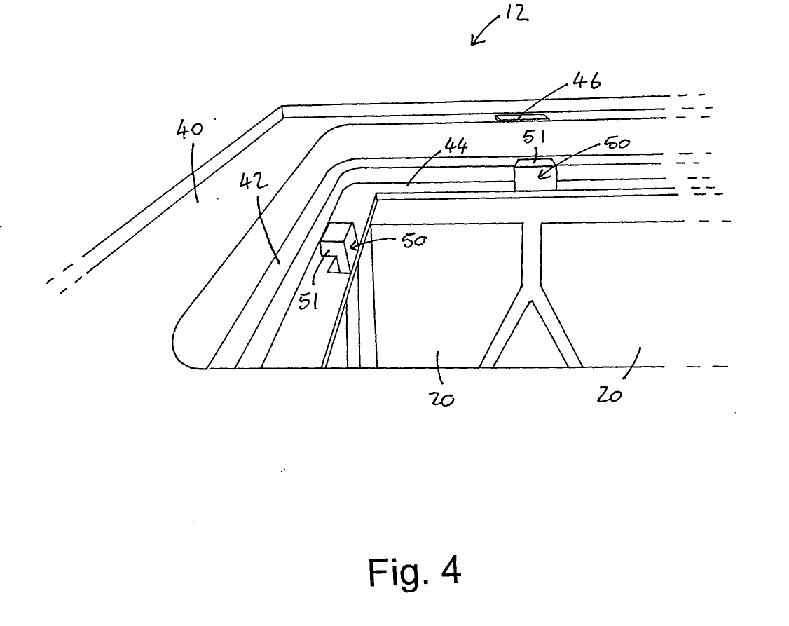

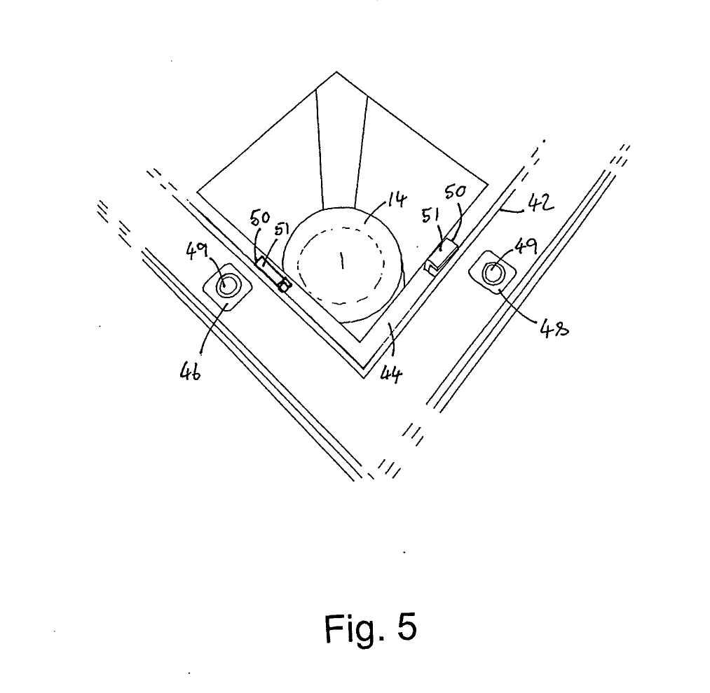

As shown more particularly in FIGS. 4 and 5, an upper portion of the base portion 12 is of generally recessed configuration and includes first, second and third ledge portions 40, 42 and 44 respectively.

Mounted on the first ledge portion 40 are first electrical contacts 46, 48 electrically connected to the light source, each of the first electrical contacts 46, 48 including a raised portion 49 shown more particularly in FIG. 5. The first electrical contacts 46, 48 are formed of resilient electrically conductive material.

Integral with the third ledge portion 44 are a plurality of first locking device 50, in this example in the form of four generally L-shaped members (only two of which are shown in FIGS. 4 and 5) arranged such that respective locking members 51 of the L-shaped members extend outwardly of the base portion 12.

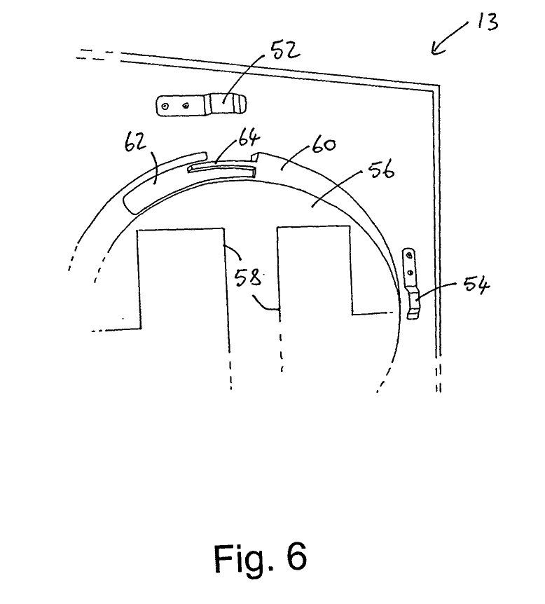

As shown more particularly in FIG. 6, a lower portion of the lid portion 13 includes second electrical contacts 52, 54 respectively, and a battery compartment 56 provided with closure members 58 removable from the battery compartment 56 so as to facilitate insertion of batteries not shown) into the battery compartment 56.

The lower portion of the lid portion 13 also includes a lip portion 60 extending around the periphery of the battery compartment 56. The lip portion 60 includes second locking devices, in this example in the form of a cavity portion 62 and a projection 64.

It will be understood that the first and second locking devices 50, 62, 64 are arranged such that when the lid portion 13 is disposed on the base portion 12 and rotated relative to the base portion 12, the first and second locking devices mechanically engage with each other so as to fix the lid portion 13 relative to the base portion 12. In this example, when the lid portion 13 is disposed on the base portion 12 and rotated relative to the base portion 12, the L-shaped member 50 locates in the cavity portion and the projection 64 locates under the locking member 51. However, it will be understood that other locking arrangements are envisaged, the important aspect being that the base portion 12 and the lid portion 13 are provided with complimentary locking devices arranged to facilitate mechanical engagement between the base portion 12 and the lid portion 13.

It will also be understood that when the lid portion 13 is disposed on the base portion 12 and rotated relative to the base portion 12, the first electrical contacts 46, 48 make electrical contact with the second electrical contacts 52, 54 so that electrical power from the batteries is supplied to the light source. The resilience of the first electrical contacts 46, 48 and the presence of the raised portions 49 on the second electrical contacts 52, 54 ensures that good electrical contact is achieved between the first electrical contacts 46, 48 and the second electrical contacts 52, 54 during use.

It will be appreciated that the lid portion 13 is both mechanically and electrically connectable to and disconnectable from the base portion 12 by disposing the lid portion 13 on the base portion 12 and rotating the lid portion relative to the base portion 12. In this way, the lid portion 13 serves as a self-contained power source and in embodiments which include solar panels 22 and rechargeable batteries, the lid portion serves as a self-contained solar rechargeable power source.

Furthermore, it will be appreciated that since the lid portion 13 is self-contained, the task of replacing the batteries is less cumbersome than with comparable light devices known hitherto.

Moreover, the invention is also applicable to other light devices and other electrical apparatus in general wherein it is desirable to provide a self-contained power source which is both mechanically and electrically connectable to an electrical apparatus requiring electrical power.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Modifications and variations as would be apparent to a skilled addressee are deemed to be within the scope of the present invention.

1. A light device comprising:
a first portion configured so as to partially define a housing, the first portion being arranged so as to at least partially pass light therethrough and the first portion including first electrical contacts and a first locking device;
a light emitting element disposed in the first portion and being electrically connected to the first electrical contacts; and
a second portion including a battery compartment, second electrical contacts arranged so as to be in electrical connection with batteries disposed in the battery compartment during use, and a second locking device engageable with the first locking device so as to releasibly fix the second portion to the first portion during use and thereby close the housing;
the arrangement being such that, during use, when the first and second locking devices are engaged with each other, the first electrical contacts electrically connect with the second electrical contacts so as to thereby electrically connect batteries disposed in the battery compartment during use to the at least one light emitting element.

2. The light device as claimed in claim 1, wherein one of the first and second locking devices includes at least one generally L-shaped member provided with an outwardly extending locking member, and the other of the first and second locking devices includes at least one cavity portion and at least one associated projection, each projection locating under a locking member when the first and second locking devices are engaged with each other.

3. The light device as claimed in claim 2, wherein four L-shaped members are provided and four corresponding cavity portions and projections.

4. The light device as claimed in claim 2, wherein the first locking device includes the at least one generally L-shaped member and the second locking device includes the at least one cavity portion and at least one associated projection.

5. The light device as claimed in claim 1, wherein each first electrical contact includes a raised portion arranged so as to encourage good electrical contact with a second electrical contact during use.

6. The light device as claimed in claim 1, wherein each second electrical contact is formed of resilient material so as to encourage good electrical contact with a first electrical contact during use.

7. The light device as claimed in claim 1, wherein the first portion is a base portion of the light device, and the second portion is a lid portion of the light device.

8. The light device as claimed in claim 1, wherein the base portion includes at least one transparent panel and a simulated candle having at least one light emitting element disposed in the simulated candle, the simulated candle being arranged so as to diffuse light passing therethrough from the at least one light emitting element.

9. The light device as claimed in claim 1, wherein the base portion includes at least one translucent panel and the at least one light emitting element is disposed in the base portion such that light from the at least one light emitting element is diffused by the at least one translucent panel.

10. The light device as claimed in claim 9, wherein the or each translucent panel may be formed of frosted glass.

11. The light device as claimed in claim 1, wherein the light device further comprises a control unit for causing the at least one light emitting element to emit flickering light.

12. The light device as claimed in claim 1, wherein the light device includes a solar power converting device arranged to convert solar power to electrical power, and an electrical power storage device arranged to store electrical power provided by the solar power converting device.
